(19) United States
(12) Patent Application Publication
(10) Pub. No.: US 2007/0209525 A1
(43) Pub. Date: Sep. 13, 2007

(54) Brew tank with integrated fluid level gauge

(76) Inventor: Michael Garman, Stafford, VA (US)

Correspondence Address: JOHN H. THOMAS, P.C., 536 GRANITE AVENUE, RICHMOND, VA, 23226, US

(21) Appl. No.: 11/372,401

(22) Filed: Mar. 9, 2006

(51) Int. Cl. A23F 5/00

(52) U.S. Cl. 99/323.3

(57) ABSTRACT

The invention relates to a brew tank with an integrated fluid level gauge, the brew tank operable with a hot beverage maker, and the fluid level gauge comprising a plurality of vertical markings or mouldings extending from the interior floor of the tank towards the upper rim of the tank. The markings are spaced along the tanks interior wall. Each mark or moulded indicator indicates a single volume indicator. For instance, a vertical rib on the interior wall of the brew tank would indicate the tank is holding 6 cups of fluid when the fluid level reaches the top of the rib.

### FIELD OF THE INVENTION

The present invention relates to a convenient hot beverage maker having a cup-actuated dispenser thereby allowing a user to dispense any amount of beverage desired, and, more particularly, pertains to a selectively removable brew tank for such a hot beverage maker wherein the brew tank includes an integrated fluid level gauge.

### BACKGROUND

Hot beverage makers, such as coffee makers, have been known and sold for many years using various brewing techniques. The typical and traditional coffee maker includes a stand or tower that has a warming plate forming the bottom or base of the tower with a filter basket located above the warming plate. The interior of the tower defines, at least in part, a fresh water reservoir. Such coffee makers further include a carafe that rests on the warming plate beneath the filter basket.

In use, an operator fills the carafe in order to transfer water to the fresh water reservoir. The water is heated and passed through the filter basket, which includes the grounds to be infused. The brewed beverage then flows from the basket into the carafe. The beverage is maintained at an elevated temperature via the warming plate upon which the carafe rests.

A new variation of coffee maker has been developed wherein a brewed beverage tank is included. Briefly, the brewed beverage tank holds the filter basket above a reservoir portion. Hot water passes through the filter basket and a material to be infused. The brewed beverage is then collected and held in the reservoir portion of the brewed beverage tank (“brew tank”). A dispenser actuator is depressed that opens an outlet port in the reservoir. A user simply actuates the dispenser actuator with a mug or cup and the brewed beverage passes through the outlet to the operator's container.

The new cup-actuated dispensers still require a volume of water to be added to a fresh water reservoir. It has been known to include a removable fresh water reservoir that can be filled and returned to the coffee maker. However, this is not always desirable or acceptable to the consumer. For instance, the removable fresh water reservoir must often be lifted vertically from the coffee maker. This is problematic in the instances where the operator has placed the coffee maker under a cabinet. The reservoir is typically located to the rear of the coffee maker so it may also be difficult to lift the reservoir for placement on the coffee maker. The removable reservoir also requires that a check valve be integrated with the reservoir.

It has also been known to use a removable brew tank as a fresh water “bucket” to transfer fresh water from a sink or other source and pour it into the fresh water reservoir. The specific level of water to be brewed is important as it largely controls the amount of infusible material to be added to the filter of the hot beverage maker. With this in mind, transparent windows and external markings have been added to the fresh water reservoir, the brew tank, or both. The windows allow a user to view the fluid level in the tank and/or fresh water reservoir. The visible level is compared to the exterior markings to determine the volume remaining in the tank or reservoir. However, for aesthetic and other reasons, the use of external markings is not always ideal.

Therefore, there exists a need for a new method and apparatus for filling a fresh water reservoir of a hot beverage maker. Ideally, the new approach would make it easy to add a specific volume of water using only components forming the overall structure of the beverage maker. The operation and structure of a brew tank with an integrated fluid gauge in accordance with the present invention would solve one or more of these or other needs.

### SUMMARY OF THE INVENTION

Accordingly, it is an object of the present invention to facilitate the filling of a fresh water reservoir in a hot beverage maker through the use of a selectively removable brew tank. A carafe or a separate container is not necessary to fill or use the hot beverage maker.

In accordance with the present invention, a hot beverage maker including a selectively removable brew tank is provided wherein the removable brew tank includes an integrated fluid level gauge. The tank includes a bottom, an outlet port in the bottom, and an interior wall surrounding the bottom. In one embodiment, the brew tank gauge comprises a plurality of vertical indicators spaced along the interior wall of the tank. The indicators begin at or adjacent to the junction of the bottom of the interior wall and terminate at a point short of the top of the wall. A label on or adjacent to each indicator identifies the specific volume of fluid in the tank when the fluid reaches the top of one of the vertical indicators. The tank is operable for placement into the hot beverage maker. The biasable outlet selectively passes a brewed beverage to a container placed beneath the tank.

In use, an operator removes the brew tank from the beverage maker. The outlet port is naturally biased to a closed or sealed position. The operator fills the tank to a desired level using the gauge indicators and labels to identify the volume of fluid. The fluid or water is added to the fresh water reservoir. A user may fill the tank and transfer the water to the fresh water reservoir more than once. The total volume is tracked using the integrated fluid level gauge. In order to dispense a brewed beverage stored in the tank, the user engages a dispenser actuator.

A hot beverage maker and brew tank with an integrated fluid level gauge in accordance with the present invention efficiently address at least one of the shortcomings associated with prior art removable brew tank beverage makers. The foregoing and additional features and advantages of the present invention will become apparent to those of skill in the art from the following detailed description of a preferred embodiment taken in conjunction with the accompanying drawings.

### BRIEF DESCRIPTION OF THE DRAWINGS

FIG. 1 is a perspective view of a hot beverage maker operable with a selectively removable brewed beverage tank;

FIG. 2 is an exploded view thereof;

FIG. 3 is a perspective view of a brewed beverage tank in accordance with one embodiment of the present invention.

FIG. 4 is an additional perspective view thereof; and

FIG. 5 is a top down view thereof.

### DETAILED DESCRIPTION

A hot beverage maker with a removable brew tank in accordance with the present invention provides an improved method and apparatus for filling the fresh water reservoir of a beverage maker. An integrated fluid gauge allows an operator to add a specific volume of fluid and, therefore, facilitates an accurate brew strength based on an operator's preferences.

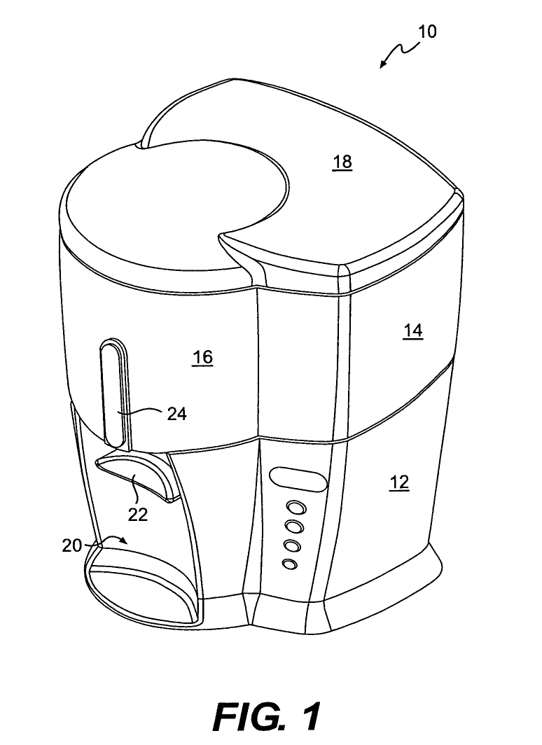

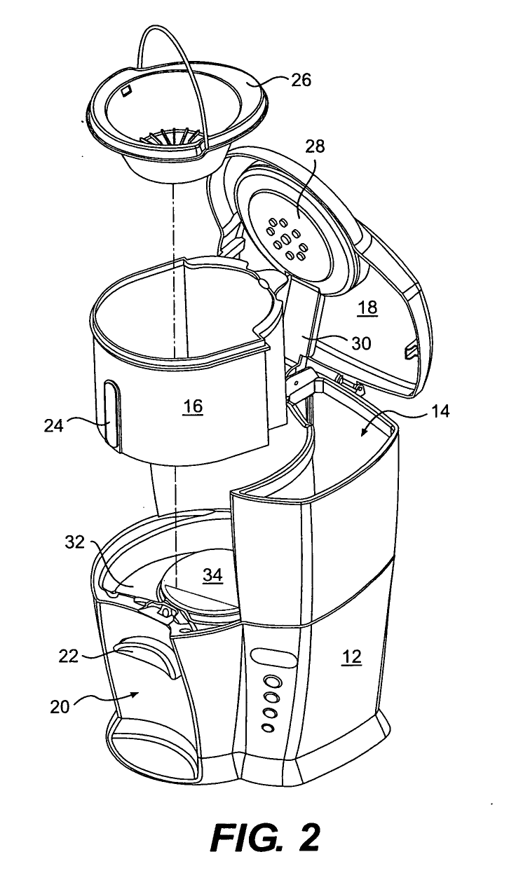

Turning to FIGS. 1 and 2, there is illustrated a hot beverage maker 10. Beverage or coffee maker 10 comprises a stand 12, a fresh water reservoir 14, a brewed beverage tank 16, and a lid 18. The stand 12 forms the base of coffee maker 10 and supports reservoir 14 and tank 16. The stand 12 includes a recess 20 in which is situated a push-button 22. Electronic controls, switches, displays and the like would be included (illustrated but not labeled). Overall, the specific construction and ornamental design of the beverage maker may vary. Therefore, a product designer or engineer having ordinary skill with the assembly and/or design of beverage makers will be able to create a beverage maker that incorporates the teachings of the present invention while incorporating a different look or different, alternative parts.

In the illustrated example, fresh water reservoir 14 located within stand 12 and the shape and design thereof is therefore, at least in part, defined by the shape and construction of the stand. Brewed beverage tank 16 also rests on stand 12. Brewed beverage tank 16 is typically opaque but, in one preferred embodiment, includes a transparent window 24 that allows a user to observe the volume of a brewed beverage within the tank (as will be discussed further below). Lid 18 is rotatably connected to reservoir 14 or stand 12. The lid is adapted to cover the upper opening of both the fresh water reservoir 14 and the brewed beverage tank 16.

FIG. 2 illustrates the beverage maker in an exploded relationship with tank 14 and a filter basket 26. Lid 18 is illustrated in the up and open position. A showerhead 28 is connected to the lid 18 and rotates up and down with the lid via a support arm 30. With tank 14 removed from stand 12, a platform 32 is visible that is adapted to support the brewed beverage tank. Platform 32 includes a warmer plate 34 that engages the bottom of the brewed beverage tank when the tank is placed on the stand. Plate 34 is operable to heat or warm the contents of tank 16. Using known techniques, brew tank 16 engages platform 32 in a manner that selectively secures tank 16 in a proper alignment.

Filter basket 26 is selectively mounted inside the tank and in the top thereof. The filter basket has a depth less than the depth of tank 16, and it includes an opening (not illustrated) at the bottom of the basket for fluid to flow through the basket into the tank 16.

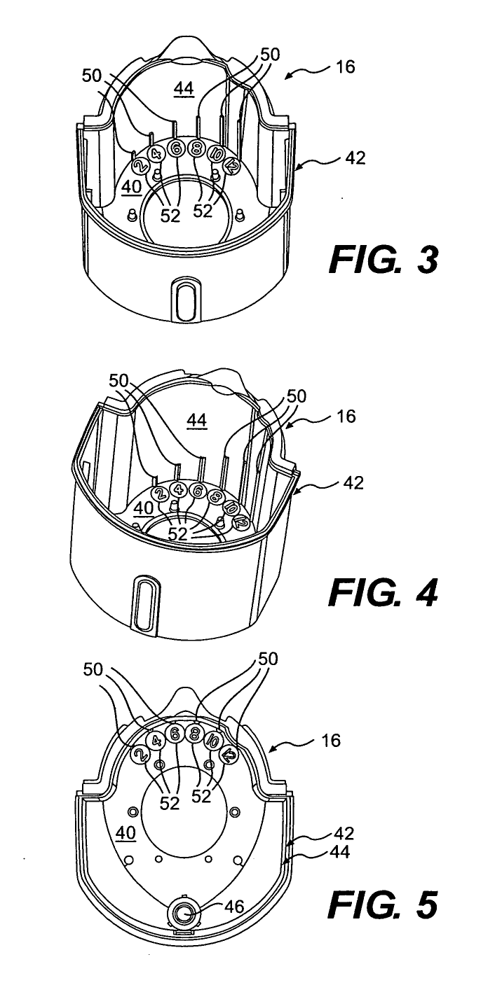

Considering also FIGS. 3-5, tank 16 includes a bottom 40 and a wall 42 surrounding the bottom and creating an interior wall 44. The specific shape of the wall may vary in accordance with the aesthetic of structural design of beverage maker 10. The interior wall and bottom define an interior volume of the tank. An outlet port 46 allows fluid in tank 16 to selectively pass out of the tank. Port 46 contains an actuatable plug or piston to selectively pass a fluid in tank 16 to a container placed within recess 20 (again, see U.S. Pat. No. 6,681,960). Push button 22 is connected to a lever operable to actuate the sealing mechanism in outlet port 46. Outlet port is naturally biased to a closed or sealed position. The lever actuates the port to an open position.

In use, fluid in the fresh water reservoir is heated via a heater. A tube fluidly connects the heater to the showerhead, and water heated in the heater is naturally lifted through the tube to the showerhead. The tube passes through, and terminates adjacent to, support arm 30. With lid 18 closed, the heated water exits the showerhead and encounters an infusible material held in filter basket 26. The resulting brewed beverage flows through the basket opening into tank 16 where it is kept warm via warmer plate 34.

It is necessary for the operator to prime or prepare the beverage maker for use. As such, water must be added to the fresh water reservoir, the filter basket must be installed in the tank, an infusible material must be added to the basket, and the tank must be installed onto the stand. A paper or permanent filter can be used with the filter basket. The operator closes the lid before turning the beverage maker on.

Tank 16 acts as a bucket to transfer fluid to the reservoir. The amount of infusible material and fluid to add to the beverage maker is dependent on many factors (number of servings, strength of the brewed beverage, etc.), and it is often important to measure the amount of fluid in the beverage maker.

In still greater detail, and in one preferred embodiment, tank 16 comprises a molded plastic. However, tank 16 can be formed out of any suitable material. The tank further includes a plurality of vertical indicators 50 on interior wall 44. The indicators might be molded ribs, graphical markings, or the like. Each indicator has a first end terminating at the bottom of the tank and a second end terminating below the top edge of wall 42. A label 52 is placed adjacent to each indicator with a single label located adjacent to each indicator 50. The labels can be molded plastic, markings, or the like.

In a preferred embodiment, labels 52 are placed on bottom 40 adjacent to indicators 50. A user, therefore, looking down into tank 16 could easily associate each label with each indicator and could easily read the label. It is also envisioned that the labels could be located on inner wall 44 near the second or top end of each indicator 50. In yet another embodiment, each indicator could be associated with two labels wherein one label would be adjacent to each end of the indicator. Other arrangements will be obvious to one of skill in the art.

The number of indicators and labels can vary but will depend, at least in part, on the capacity of tank 16. Each label marks the volume of a fluid in tank 16 when the fluid is at the top end of any one indicator. The increments and units of measurements may also vary. As illustrated in FIGS. 3-5, tank 16 has a capacity of 12 cups. A labeled indicator marks each even increment of cups from 2 to 12 cups. Therefore, when adding water to the tank, the user knows the tank holds two cups when the water reaches the top of the indicator labeled “2”. The volume is then between 2 to 4 cups until the fluid level reaches the top of the indicator labeled 4 and so forth.

In use, the user removes tank 16 from stand 12. Outlet port 46 automatically closes. The user removes filter basket 26 from tank 16. Tank 16 is filled to a desired volume and the water is added to fresh water reservoir 14. If the operator needs to add additional fluid, the volume can be measured with the tank to reach a total desired volume of fluid in reservoir 14. The beverage maker is then operated as discussed above. The user engages push button 22 with a container. Button 22, via the lever, actuates port 46 to an open position and a brewed beverage flows from tank 16 to the user's container. Window 24 provides a visual indication of how much brewed beverage remains in tank 16. In one embodiment, window 24 is operable to view indicators 50 and/or labels 52 to accurately gauge the remaining volume of beverage in tank 16.

Thus, while the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. A hot beverage maker comprising a stand and a brewed beverage tank, the brewed beverage tank selectively removable from the beverage maker wherein the brewed beverage tank comprises:
a bottom;
an interior wall surrounding and secured to the bottom, the wall having a top edge;
an outlet port positioned to selectively pass a fluid through the bottom of the tank;
a plurality of vertical indicators on the interior wall, the indicators having a first end terminating at the bottom of the tank and a second end terminating below the top edge; and
wherein each indicator includes a label to signify a volume of fluid in the tank.

2. A brewed beverage tank as described in claim 1, wherein the outlet port automatically prohibits fluid passing through the bottom of the tank when the tank is removed from the beverage maker.

3. A brewed beverage tank as described in claim 2, further comprising a dispenser actuator, and wherein the dispenser actuator is operable to bias the outlet port between an open position and a closed position.

4. A brewed beverage tank as described in claim 1, further comprising a filter basket selectively mounted inside the tank.

5. A brewed beverage tank as described in claim 4, wherein the filter basket has a depth less than the depth of the tank.

6. A brewed beverage tank as described in claim 1, further comprising a transparent window located in the wall of the tank.

7. The brewed beverage tank of claim 6, wherein the labels are visible via the transparent window.

8. A hot beverage maker comprising a stand and a brewed beverage tank, the brewed beverage tank selectively removable from the beverage maker wherein the brewed beverage tank comprises:
a bottom;
an interior wall surrounding and secured to the bottom, the wall having a top edge;
a biasable outlet port positioned to selectively prohibit or allow the passage of a fluid through the bottom of the tank, the outlet port naturally biased to a closed position;
a dispenser actuator, the dispenser actuator operable to bias the outlet port between an open position and the closed position;
a plurality of vertical indicators on the interior wall, the indicators having a first end terminating at the bottom of the tank and a second end terminating below the top edge; and
wherein each indicator includes a label to signify a volume of fluid in the tank.

9. A brewed beverage tank as described in claim 8, further comprising a filter basket selectively mounted inside the tank.

10. A brewed beverage tank as described in claim 9, wherein the filter basket has a depth less than the depth of the tank.

11. A brewed beverage tank as described in claim 8, further comprising a transparent window located in the wall of the tank.

12. A hot beverage maker comprising a stand and a brewed beverage tank, the brewed beverage tank selectively removable from the beverage maker wherein the brewed beverage tank comprises:
a bottom;
an interior wall surrounding and secured to the bottom, the wall having a top edge;
an outlet port positioned to selectively pass a fluid through the bottom of the tank;
a filter basket selectively mounted inside the tank, the filter basket having a depth less than the depth of the tank;
a plurality of vertical indicators on the interior wall, the indicators having a first end terminating at the bottom of the tank and a second end terminating below the top edge; and
wherein each indicator includes a label to signify a volume of fluid in the tank.

13. A brewed beverage tank as described in claim 12, wherein the outlet port automatically prohibits fluid passing through the bottom of the tank when the tank is removed from the beverage maker.

14. A brewed beverage tank as described in claim 13, further comprising a dispenser actuator, and wherein the dispenser actuator is operable to bias the outlet port between an open position and a closed position.

15. A brewed beverage tank as described in claim 13, further comprising a transparent window located in the wall of the tank.

16. The brewed beverage tank of claim 15, wherein the labels are visible via the transparent window.
